(19) United States
(12) Patent Application Publication
(10) Pub. No.: US 2025/0362132 A1
(43) Pub. Date: Nov. 27, 2025

(54) Vehicle Control Device and Vehicle Control Method

(71) Applicants: Hyundai Motor Company, Seoul (KR); Kia Corporation, Seoul (KR)

(72) Inventors: Myung Kyum Kim, Hwaseong-Si (KR); Se Hyun Yun, Hwaseong-Si (KR)

(21) Appl. No.: 18/965,651

(22) Filed: Dec. 2, 2024

(30) Foreign Application Priority Data
May 24, 2024 (KR) 10-2024-0068043

(51) Int. Cl. G01C 21/30; B60W 30/10; G01C 21/00

(52) U.S. Cl. CPC G01C 21/30; B60W 30/10; G01C 21/3815; B60W 2552/53

(57) ABSTRACT

A vehicle control device may include a processor, a memory, and a sensor. The processor may obtain a plurality of candidate datasets for identifying a change in line, by comparing line information included in a precision map and line sensing data obtained via the sensor, remove a positioning bias for each of the plurality of candidate datasets during a time period including a time point at which the line sensing data is obtained, identify a first dataset from which the positioning bias has been removed and a second dataset that is distinct from the first dataset among the plurality of candidate datasets, obtain line change information including the second dataset, and control a vehicle based on the line change information.

### CROSS-REFERENCE TO RELATED APPLICATION

This application claims the benefit of priority to Korean Patent Application No. 10-2024-0068043, filed in the Korean Intellectual Property Office on May 24, 2024, the entire contents of which are incorporated herein by reference.

### TECHNICAL FIELD

The present disclosure relates to a vehicle control device and a vehicle control method, and more specifically, to a technology for identifying line change information.

### BACKGROUND

An autonomous vehicle may provide self-driving services by performing positioning and control of the vehicle using a high-definition map (HD Map). The high-definition map may include traffic signs and road markings, and may be created based on a mobile mapping system (MMS) technology. The high-definition map may require not only accurate location information but also maintenance of up-to-date information in terms of vehicle positioning and vehicle control. If a line on the high-definition map and an actual line on a road (e.g., a road marking) are different due to any changes in the road (e.g., new road constructions, detours, etc.), autonomous vehicles may have difficulty performing reliable positioning and control of the vehicle, making it necessary to update the high-definition map frequently. Therefore, a method for determining map change intervals using sensing data acquired while an autonomous vehicle is driving on the road may be required.

### SUMMARY

The present disclosure has been made to solve the above-mentioned problems occurring in at least some implementations while advantages achieved by those implementations are maintained intact.

An aspect of the present disclosure provides a vehicle control device and a vehicle control method for using sensing data including noise.

An aspect of the present disclosure provides a vehicle control device and a vehicle control method for identifying map change intervals using sensing data and a precision map (or high definition map).

An aspect of the present disclosure provides a vehicle control device and a vehicle control method for determining whether there is a change in an actual line by comparing line sensing data with line information included in a precision map based on a chi-squared test.

The technical problems to be solved by the present disclosure are not limited to the aforementioned problems, and any other technical problems not mentioned herein will be clearly understood from the following description by those skilled in the art to which the present disclosure pertains.

According to one or more example embodiments of the present disclosure, a vehicle control device may include: a processor; memory; and a sensor. The processor may be configured to: determine, based on a comparison between line information included in a road map and line sensing data obtained via the sensor, a plurality of candidate datasets for identifying a change in a line associated with a road, wherein the plurality of candidate datasets correspond to a time period associated with the line sensing data; perform a positioning bias reduction process on each of the plurality of candidate datasets; identify, among the plurality of candidate datasets: a first dataset from which a positioning bias has been reduced, and a second dataset different from the first dataset; determine, based on the second dataset, line change information; and control, based on the line change information, a vehicle.

The processor may be configured to determine the plurality of candidate datasets by: identifying a first line included in the line information; identifying, based on the line sensing data, a second line corresponding to the first line; determining a statistical quantity representing a deviation of the second line with respect to the first line; and determining, based on the statistical quantity being greater than a threshold value, a candidate dataset, of the plurality of candidate datasets, that corresponds to the second line.

The candidate dataset corresponding to the second line may include at least one of: a sensor bias indicating a misreading of the sensor, the positioning bias, or the line change information representing a change associated with the second line.

The processor may be further configured to: identify a first line included in the line information; identify, based on the line sensing data, a second line corresponding to the first line; and determine, based on a comparison of a location of the first line with a location of the second line, a statistical quantity representing a deviation of the second line with respect to the first line.

The processor may be further configured to: remove, through filtering, a sensor bias representing misreading of the sensor.

The processor may be configured to perform the positioning bias reduction process by: identifying a first line included in the line information; identifying, based on the line sensing data, a second line corresponding to the first line; determining a first time at which the second line was detected by the sensor; determining the positioning bias by performing forward positioning in a first direction from the first time to a second time at which a deviation of the second line with respect to the first line is less than a threshold value; and determining whether the positioning bias has been reduced by performing reverse positioning in a second direction from the second time to the first time.

The processor may be configured to identify the first dataset by: identifying a candidate dataset, of the plurality of candidate datasets, as the first dataset based on the positioning bias having been reduced after the reverse positioning is performed on the candidate dataset.

The processor may be configured to identify the second dataset by: identifying a candidate dataset, of the plurality of candidate datasets, as the second dataset based on the positioning bias not having been reduced after the reverse positioning is performed on the candidate dataset.

The processor may be further configured to determine that the positioning bias has been reduced based on a first statistical quantity being less than a second statistical quantity. The first statistical quantity may be associated with a second deviation of the second line with respect to the first line after performing the reverse positioning. The second statistical quantity may be associated with the deviation of the second line with respect to the first line before performing the forward positioning.

The line sensing data may include at least one of: a line, a road boundary shape, a road sign, or a road marking.

According to one or more example embodiments of the present disclosure, a method performed by an apparatus of a vehicle may include: determining, based on a comparison between line information included in a road map and line sensing data obtained via a sensor, a plurality of candidate datasets for identifying a change in a line associated with a road, wherein the plurality of candidate datasets correspond to a time period associated with the line sensing data; performing a positioning bias reduction process on each of the plurality of candidate datasets; identifying, among the plurality of candidate datasets: a first dataset from which a positioning bias has been reduced, and a second dataset different from the first dataset; determining, based on the second dataset, line change information; and controlling, based on the line change information, the vehicle.

Determining the plurality of candidate datasets may include: identifying a first line included in the line information; identifying, based on the line sensing data, a second line corresponding to the first line; determining a statistical quantity representing a deviation of the second line with respect to the first line; and determining, based on the statistical quantity being greater than a threshold value, a candidate dataset, of the plurality of candidate datasets, that corresponds to the second line.

The candidate dataset corresponding to the second line may include at least one of: a sensor bias indicating a misreading of the sensor, the positioning bias, or the line change information representing a change associated with the second line.

The method may further include: identifying a first line included in the line information; identify, based on the line sensing data, a second line corresponding to the first line; and determining, based on a comparison of a location of the first line with a location of the second line, a statistical quantity representing a deviation of the second line with respect to the first line.

The method may further include: removing, through filtering, a sensor bias representing misreading of the sensor.

Performing the positioning bias reduction process may include: identifying a first line included in the line information; identifying, based on the line sensing data, a second line corresponding to the first line; determining a first time at which the second line was detected by the sensor; determining the positioning bias by performing forward positioning in a first direction from the first time to a second time at which a deviation of the second line with respect to the first line is less than a threshold; and determining whether the positioning bias has been reduced by performing reverse positioning in a second direction from the second time to the first time.

Identifying the first dataset may include: identifying a candidate dataset, of the plurality of candidate datasets, as the first dataset based on the positioning bias having been reduced after the reverse positioning is performed on the candidate dataset.

Identifying the second dataset may include: identifying a candidate dataset, of the plurality of candidate datasets, as the second dataset based on the positioning bias not having been reduced after the reverse positioning is performed on the candidate dataset.

The method may further include: determining that the positioning bias has been reduced based on a first statistical quantity being less than a second statistical quantity. The first statistical quantity may be associated with a second deviation of the second line with respect to the first line after performing the reverse positioning. The second statistical quantity may be associated with the deviation of the second line with respect to the first line before performing the forward positioning.

The line sensing data may include at least one of: a line, a road boundary shape, a road sign, or a road marking.

### BRIEF DESCRIPTION OF THE DRAWINGS

The above and other objects, features and advantages of the present disclosure will be more apparent from the following detailed description taken in conjunction with the accompanying drawings:

FIG. 1 illustrates an example of a block diagram relating to a vehicle control device;

FIG. 2 shows an example of line information and line sensing data identified by a vehicle control device;

FIG. 3 shows an example for describing an operation in which a vehicle control device compares line information and line sensing data;

FIGS. 4A and 4B show an example for describing an operation of identifying a candidate dataset in a vehicle control device;

FIG. 5 shows an example of forward positioning or reverse positioning performed by a vehicle control device;

FIGS. 6A and 6B illustrate an example for explaining an operation of a vehicle control device to reduce or remove a positioning bias;

FIG. 7 shows an example of a flowchart showing the operation of a vehicle control device;

FIG. 8 shows an example of a flowchart showing a vehicle control method; and

FIG. 9 shows a computing system related to a vehicle control device or a vehicle control method.

### DETAILED DESCRIPTION

Hereinafter, one or more example embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the example embodiment of the present disclosure, a detailed description of well-known features or functions will be ruled out in order not to unnecessarily obscure the gist of the present disclosure.

In describing the components of one or more example embodiments of the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The term “module” used in various embodiments of the present disclosure may represent, for example, a unit including one or more combinations of hardware, software and firmware. The term “module” may be interchangeably used with the terms “unit”, “logic”, “logical block”, “part” and “circuit”. The “module” may be a minimum unit of an integrated part or a part thereof or may be a minimum unit for performing one or more functions or a part thereof. In one embodiment, the module may be implemented in the form of an application-specific integrated circuit (ASIC). According to various embodiments, operations performed by modules, programs, or other components may be executed sequentially, in parallel, or repeatedly, or one or more of the operations may be executed in a different order, omitted, or one or more other operations may be added.

Various embodiments of the present disclosure may be implemented with software (e.g., a program) that includes one or more instructions stored in a storage medium (e.g., internal memory or external memory) which is readable by a machine (e.g., a vehicle control device 100). For example, a processor (e.g., a processor 110) of a device (e.g., the vehicle control device 100) may call at least one instruction among one or more instructions stored from a storage medium and execute the at least one instruction. This enables the device to be operated to perform at least one function according to the at least one command invoked. The one or more instructions may contain a code made by a compiler or a code executable by an interpreter. The machine-readable storage medium may be provided in the form of a non-transitory storage medium. Here, the term “non-transitory storage medium” may mean that the storage medium is a tangible device and does not include signals (e.g., electromagnetic waves), and may mean that data may be semi-permanently or temporarily stored in the storage medium.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., determining line change information) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., determining line change information) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., determining line change information) described herein.

Minimum risk maneuver (MRM) operation(s) may also be controlled, for example, based on one or more features (e.g., determining line change information) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., determining line change information) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., determining line change information) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

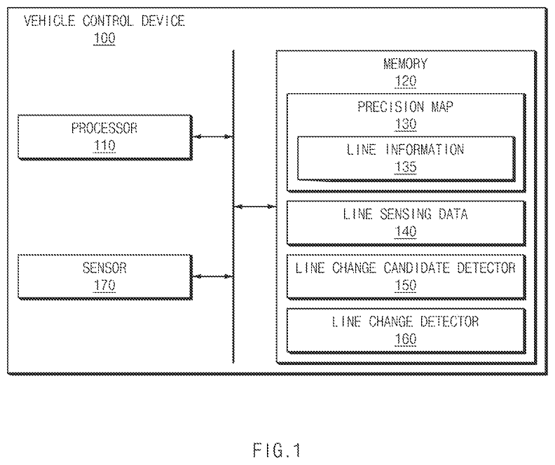

Hereinafter, one or more example embodiments of the present disclosure will be described in detail with reference to FIGS. 1 to 9.

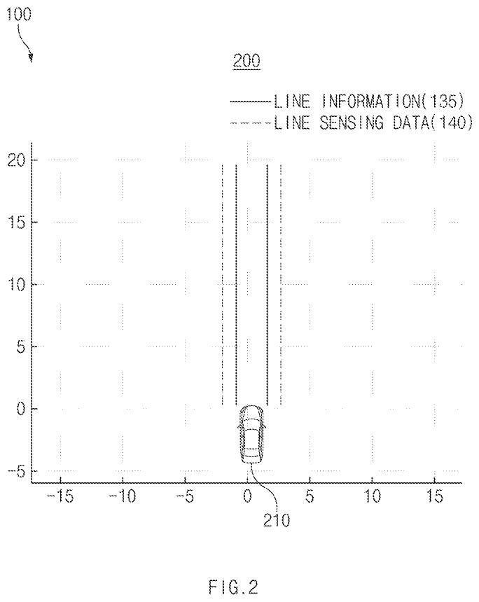

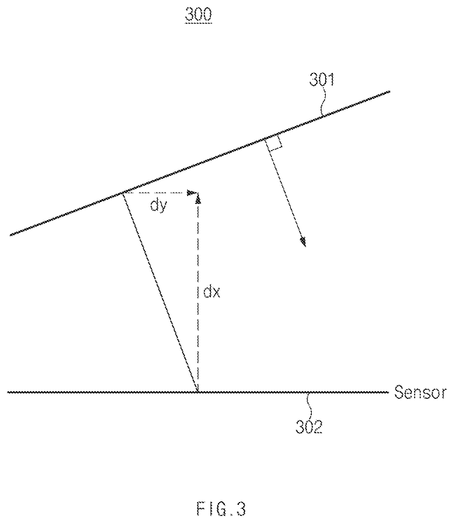

FIG. 1 shows an example of a block diagram relating to a vehicle control device. FIG. 2 shows an example of line information and line sensing data identified by a vehicle control device. FIG. 3 shows an example for describing an operation in which a vehicle control device compares line information and line sensing data.

Referring to FIG. 1, the vehicle control device 100 may be implemented inside or outside a vehicle, and part of components included in the vehicle control device 100 may be implemented inside or outside the vehicle. In this case, the vehicle control device 100 may be integrally formed with internal control units of the vehicle, or may be implemented as a separate device and connected to the control units of the vehicle by separate connection means. For example, the vehicle control device 100 may further include components not shown in FIG. 1.

The vehicle control device 100 may include at least one of the processor 110, a memory 120, or a sensor 170. The processor 110, the memory 120, or the sensor 170 may be electronically and/or operably coupled with each other by an electronical component including a communication bus. Hereinafter, hardware being operatively combined may mean that a direct connection or an indirect connection between the hardware is established in a wired or wireless manner, such that second hardware is controlled by first hardware among the hardware. Although shown based on different blocks, embodiments are not limited thereto, and a portion of the hardware in FIG. 1 (e.g., at least a portion of the processor 110, the memory 120, and a communication circuitry (not shown)) may be included in a single integrated circuit, such as a system on a chip.

The processor 110 of the vehicle control device 100 may include a hardware component for processing data based on one or more instructions. The hardware component for processing data may include, for example, an arithmetic and logic unit (ALU), a floating-point unit (FPU), a field programmable gate array (FPGA), a central processing unit (CPU), a micro controller unit (MCU), and/or an application processor (AP). The number of processors 110 may be one or more. For example, the processor 110 may have the structure of a multi-core processor including dual core, quad core, hexa core, or octa core.

The memory 120 of the vehicle control device 100 may include hardware components for storing data and/or instructions that are input to and/or output from the processor 110. For example, the memory 120 may include a volatile memory, such as a random-access memory (RAM), and/or a non-volatile memory, such as a read-only memory (ROM). For example, the volatile memory may include at least one of dynamic RAM (DRAM), static RAM (SRAM), cache RAM, and pseudo SRAM (PSRAM). For example, the non-volatile memory may include at least one of programmable ROM (PROM), erasable PROM (EPROM), electrically erasable PROM (EEPROM), flash memory, hard disk, compact disc (CD), and embedded multi-media card (eMMC).

The sensor 170 of the vehicle control device 100 may generate electronic information, capable of being processed by the processor 110 and/or the memory 120 of the vehicle control device 100, from non-electronic information related to the vehicle control device 100.

The sensor 170 may include one or more sensors. For example, the sensor 170 may be attached to different locations on the vehicle. The sensor 170 may face one or more different directions. For example, the sensor 170 may be attached to the front, sides, rear and/or roof of the vehicle to face directions such as a forward-facing direction, a rear-facing direction, a side-facing direction, and/or the like. However, the present disclosure is not limited thereto.

The sensor 170 may include an image sensor, such as high dynamic range cameras. For example, the sensors 170 may include non-visual sensors. For example, the sensors 170 may include a RADAR, a light detection and ranging (LiDAR), and/or an ultrasonic sensor in addition to the image sensor.

The sensor 170 may be an attitude sensor (e.g., yaw sensor, roll sensor, or pitch sensor), a crash sensor, a wheel sensor, a speed sensor, an inclination sensor, a weight sensor, a heading sensor, a gyro sensor, an acceleration sensor, an inertial measurement unit (IMU), position module, a vehicle forward/reverse sensor, a battery sensor, a fuel sensor, a tire sensor, a steering sensor by wheel rotation, a vehicle interior temperature sensor, a vehicle interior humidity sensor, an ultrasonic sensor, an illuminance sensor, an accelerator pedal position sensor, and/or a brake pedal position sensor. However, the present disclosure is not limited thereto.

For example, the vehicle control device 100 may obtain, via the sensors 170, vehicle attitude information, vehicle collision information, vehicle direction information, vehicle position information (e.g. GPS (global positioning system) information), vehicle angle information, vehicle speed information, vehicle acceleration information, vehicle tilt information, vehicle forward/backward information, battery information, fuel information, tire information, vehicle lamp information, vehicle interior temperature information, vehicle interior humidity information, steering wheel rotation angle, vehicle exterior illumination, or sensing data related to a pressure applied to the accelerator pedal and/or a pressure applied to the brake pedal. However, the present disclosure is not limited thereto.

The vehicle control device 100 may control notification systems including warning systems for notifying a driver of driving events such as approaching a destination or potential collision. For example, the vehicle control device 100 may adjust the sensor 170 of the vehicle. For example, the vehicle control device 100 may modify the orientation of the sensor 170. The vehicle control device 100 may change the output resolution and/or format type of the sensor 170. The vehicle control device 100 may change (e.g., increase or decrease) a capture rate. The vehicle control device 100 may adjust the dynamic range of the sensor 170. The vehicle control device 100 may control the operation of the sensors 170 individually or collectively (e.g., turn-on or turn-off).

The vehicle control device 100 may perform deep learning analysis on sensor data received from the sensor 170. The vehicle control device 100 may be coupled via an input/output interface to the memory 120 configured to provide a process with instructions that cause to determine deep learning results used to operate the vehicle at least partially autonomously. For example, the vehicle control device 100 may process commands for vehicle control, which are output from the processor 110. To control various modules of the vehicle, the vehicle control device 100 may translate the output of the processor 110 into instructions for controlling the modules of the vehicle.

The vehicle control device 100 may obtain sensing data representing the location of the vehicle, the movement path of the vehicle, the posture of the vehicle, and/or at least one object (e.g., line) located around the vehicle, by using the sensor 170.

The vehicle control device 100 may obtain line sensing data 140 identified based on the movement direction of the vehicle, via the sensor 170. The vehicle control device 100 may compare line information 135 included in a precision map 130 and the line sensing data 140.

For example, the precision map 130 may include semantic information representing lines, road boundaries, road markings, and/or road signs (e.g., traffic signs). The precision map 130 may be map data (e.g., road map data).

For example, the line sensing data 140 may include line recognition results obtained via the sensor 170. The line sensing data 140 may include error values over time or due to the characteristics of sensor data. For example, the line sensing data 140 may include at least one of a line, a road boundary, a road sign, or a road marking, or any combination thereof.

Because the precision map 130 (e.g., HD map) and the line sensing data 140 include information about road boundaries, road markings, and/or road signs, the vehicle control device 100 may determine whether there is a change not only in line, but also in road boundary, road marking, and/or road sign.

The vehicle control device 100 may compare the line information 135 included in the precision map 130 with the line sensing data 140 obtained via the sensor 170 to obtain a plurality of candidate datasets for identifying a change in line.

The vehicle control device 100 may perform a positioning bias removal process (also referred to as a positioning bias reduction process) to attempt to reduce or remove a positioning bias (also referred to as a localization bias) from each of the plurality of candidate datasets. The plurality of candidate datasets may correspond to a time period associated with obtaining the line sensing data 140.

For example, the positioning bias may include a positioning error of lines identified based on misrecognition (e.g., misreading) of sensor 170. The positioning bias may include a positioning error (e.g., deviation) between sensing data and line information included in the precision map. For example, the positioning bias may have characteristics in which the positioning bias occurs in a specific interval and is then reduced. For example, a positioning bias occurs if there is no sensing data recognized around the vehicle at an intersection or in some specific environments, and may have the characteristic in which the positioning bias is reduced if sensing data is identified via a sensor.

The vehicle control device 100 may identify a first dataset from which positioning bias has been reduced or removed and a second dataset that is distinct from the first dataset, among a plurality of candidate datasets. The vehicle control device 100 may obtain line change information including the second dataset (e.g., obtain line change information based on the second dataset). The vehicle control device 100 may control the vehicle based on the line change information. For example, if the vehicle control device 100 identifies an interval where an actual line has changed based on the line change information, the vehicle control device 100 may transfer (or authorize) control of the vehicle to a user. For example, the vehicle control device 100 may update at least part of the precision map using the line change information.

The vehicle control device 100 may identify a first line 301 included in the line information 135. The vehicle control device 100 may identify a second line 302 corresponding to the first line 301 using the line sensing data 140.

For example, the vehicle control device 100 may compare the first line 301 included in the line information 135 and/or the second line 302 included in the line sensing data 140 based on the execution of a line change candidate detector 150.

The vehicle control device 100 may identify a statistical quantity representing the error (e.g., deviation) of the second line 302 with respect to the first line 301.

The vehicle control device 100 may identify a statistical quantity representing the error (e.g., deviation) of the second line 302 with respect to the first line 301, based on a chi-squared test by comparing the location of the first line 301 and the location of the second line 302. For example, if the statistical quantity is greater than a specified value, the vehicle control device 100 may obtain a plurality of candidate datasets including a candidate dataset corresponding to the second line 302.

For example, the vehicle control device 100 may compare the location of the first line 301 and the location of the second line 302, which are expressed based on two dimensions, to identify the error (e.g., deviation) of the second line 302 with respect to the first line 301. For example, the vehicle control device 100 may compare the longitudinal error (e.g., the longitudinal deviation) (e.g., dy in FIG. 3) and the lateral error (e.g., the lateral deviation) (e.g., dx in FIG. 3) based on the driving direction of a vehicle 210, respectively to identify the error (e.g., deviation) of the second line 302 with respect to the first line 301. Examples 200 of the first line 301 and the second line 302 expressed based on two dimensions may be shown as shown in FIG. 2.

Referring to FIG. 2, the vehicle control device 100 may identify the line information 135 and the line sensing data 140 corresponding to the line information 135 based on the driving direction of the vehicle 210. The vehicle control device 100 may identify the line sensing data 140 that matches the line information 135 based on the location of the vehicle 210. Hereinafter, an example 300 for comparing the first line 301 included in the line information 135 and the second line 302 included in the line sensing data 140 will be described below with reference to FIG. 3.

Referring to FIG. 3, in the example 300, the vehicle control device 100 may obtain a plurality of candidate datasets for identifying an actual line change.

The vehicle control device 100 may obtain a statistical quantity representing the error (e.g., lateral error and/or longitudinal error) of the second line 302 with respect to the first line 301 based on a chi-squared test.

The chi-squared test may refer to a method of verifying the consistency of data based on the test statistical quantity of chi-squared distribution. For example, the chi-squared test may be used to test a hypothesis using the chi-square distribution if the statistical quantity follows the chi-square distribution. For example, a hypothesis may include a null hypothesis and an alternative hypothesis. For example, the vehicle control device 100 may select the alternative hypothesis among the null hypothesis and the alternative hypothesis if the statistical quantity is smaller than a threshold.

For example, in statistics, the null hypothesis may refer to a hypothesis that is expected to be discarded from the beginning. The alternative hypothesis may refer to a hypothesis that is alternatively true (e.g., 1) if the null hypothesis is false (e.g., 0).

For example, the null hypothesis may be set (or defined) to mean that ‘the distribution of sample groups will be similar.’ The alternative hypothesis may be set to mean that ‘the distribution of sample groups will not be similar.’

In other words, the fact that the distribution of sample groups is similar indicates an unbiased distribution, so the null hypothesis may be defined as “an error in the matched segments (e.g., the first line 301 and the second line 302) contains noise.” The alternative hypothesis may be defined as “matched line segments contain noise and bias errors.”

For example, noise may include an error value identified based on misrecognition (e.g., misreading) of the sensor 170. For example, the bias error may include an error value identified based on a misrecognition (e.g., misreading) of the sensor 170, a sensor bias calculated through a chi-square test, a positioning bias, and/or line change information representing an actual line change.

For example, the vehicle control device 100 may obtain a statistical quantity (or chi-squared test statistical quantity) using Equation 1.

$$δ x ≡ {x}_{m} - {x}_{s} = ( {x}_{GT} - {x}_{m} ) - ( {x}_{GT} - {x}_{s} ) = - \qquad [ Equation 1 ]$$

Referring to Equation 1, xₘ may represent a first line component (e.g., the first line 301) obtained using the line information 135. xₛ may represent a second line component (e.g., the second line 302) obtained using the line sensing data 140. x_{GT} may represent an actual line corresponding to the first line component and the second line component. Δx may represent the error between the first line component and the second line component.

The vehicle control device 100 may use Equation 2 to obtain the covariance for the error identified through Equation 1.

$${P}_{δ x} ≡ - - + \approx 2 \qquad [ Equation 2 ]$$

Equation 2 may mean that the first line component and the second line component represent substantially the same actual line. The vehicle control device 100 may obtain a statistical quantity representing the error of the second line component with respect to the first line component based on Equation 2. To obtain reliability for the statistical quantity, the vehicle control device 100 may use Equation 3.

$${k}^{2} = δ {{x}^{T} [ {P}_{δ x} ]}^{- 1} δ x \qquad [ Equation 3 ]$$

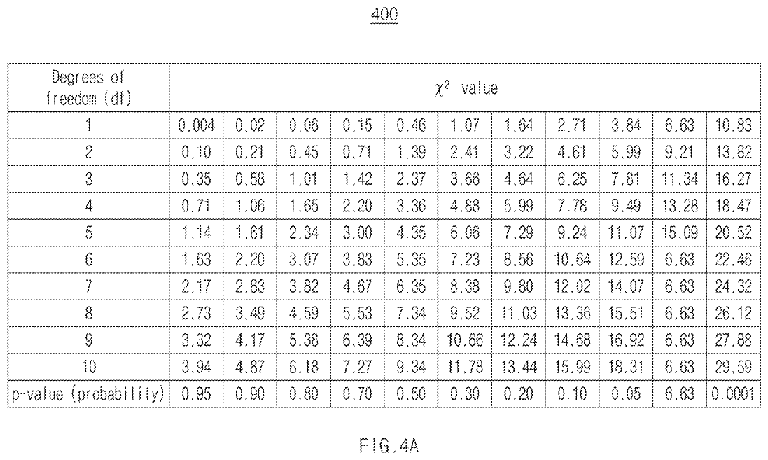

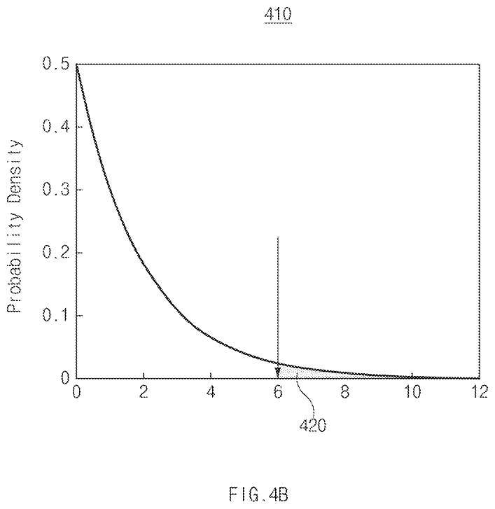

Using Equations 1 to 3, the vehicle control device 100 may compare a plurality of line components included in the line information 135 and a plurality of line components included in the line sensing data 140 respectively, to obtain statistical quantities based on chi-squared tests. The vehicle control device 100 may obtain a plurality of candidate datasets for identifying a line change using a probability-value. The vehicle control device 100 may divide a plurality of candidate datasets into first datasets and second datasets depending on whether the positioning bias has been reduced or removed. For example, an operation in which the vehicle control device 100 obtains a plurality of candidate datasets using a probability-value (e.g., p-value) will be described later with reference to FIGS. 4A and 4B.

As described above, the vehicle control device 100 may obtain the line sensing data 140 using the sensor 170 that is different from a mobile mapping system (MMS). The line sensing data 140 obtained by the vehicle control device 100 using the sensor 170 may include noise based on the performance of the sensor 170. The vehicle control device 100 may identify a plurality of candidate datasets for determining whether a line has actually changed, based on a chi-squared test that is robust to noise. The vehicle control device 100 may more accurately determine whether a line change has occurred by identifying a plurality of candidate datasets based on the chi-squared test.

FIGS. 4A and 4B show an example for describing an operation of identifying a candidate dataset in a vehicle control device. The vehicle control device 100 of FIGS. 4A and 4B may be referenced to the vehicle control device 100 of FIG. 1.

Referring to FIG. 4A, a table 400 (e.g., a chi-square distribution table) is shown which shows statistical quantities (X²) relative to probability levels (or probability values) and degrees of freedom. Referring to the table 400, assuming the reliability of the error is a predetermined value (e.g., 95%), a specified value (e.g., 5.99) corresponding to the probability level (e.g., 0.05) and the degree of freedom (e.g., 2) may be obtained based on the chi-squared distribution. However, the present disclosure is not limited thereto.

Referring to FIG. 4B, a graph 410 (e.g., probability density function) is shown for the vehicle control device 100 to identify a plurality of candidate datasets based on the chi-squared distribution. Referring to the graph 410, if the statistical quantity (e.g., k² in Equation 3) identified using Equation 1 to Equation 3 is less than a specified value (e.g., 5.991), the null hypothesis may be adopted. In other words, the vehicle control device 100 may infer that a candidate dataset corresponding to a statistical quantity which is less than the specified value includes noise. For example, a candidate dataset corresponding to the statistical quantity which is less than the specified value may not be used to identify a line change.

If the statistical quantity is greater than the specified value, the null hypothesis may be rejected. In other words, the vehicle control device 100 may infer that a candidate dataset corresponding to the statistical quantity greater than the specified value includes noise and a bias error.

The vehicle control device 100 may identify a plurality of candidate datasets corresponding to statistical quantities included in an area 420, which is greater than the specified value.

For example, if the statistical quantity is greater than the specified value, the plurality of candidate datasets may include at least one of a sensor bias indicating sensor misrecognition (e.g., misreading), a positioning bias, or line change information indicating the actual line change corresponding to the plurality of candidate datasets, or any combination thereof.

Based on the execution of a line change detector 160 of FIG. 1, the vehicle control device 100 may perform forward positioning and/or reverse positioning on each of the plurality of candidate datasets to determine whether the positioning bias has been reduced or removed. The vehicle control device 100 may identify a first dataset from which the positioning bias has been reduced or removed and a second dataset from which the positioning bias has not been reduced or removed among the plurality of candidate datasets. The vehicle control device 100 may obtain line change information including the second dataset. The vehicle control device 100 may obtain line change information based on the second dataset.

For example, the vehicle control device 100 may reduce or remove a sensor bias included in each of the plurality of candidate datasets through filtering before performing forward positioning and/or reverse positioning. The vehicle control device 100 may reduce or remove the sensor bias by performing sensor fusion using a plurality of sensors. However, the present disclosure is not limited thereto.

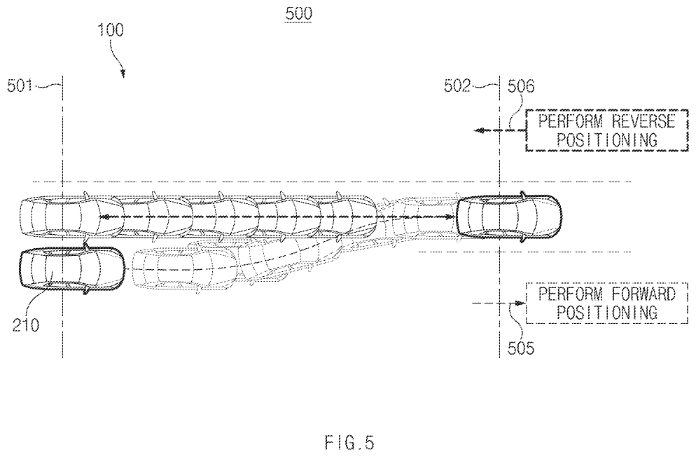

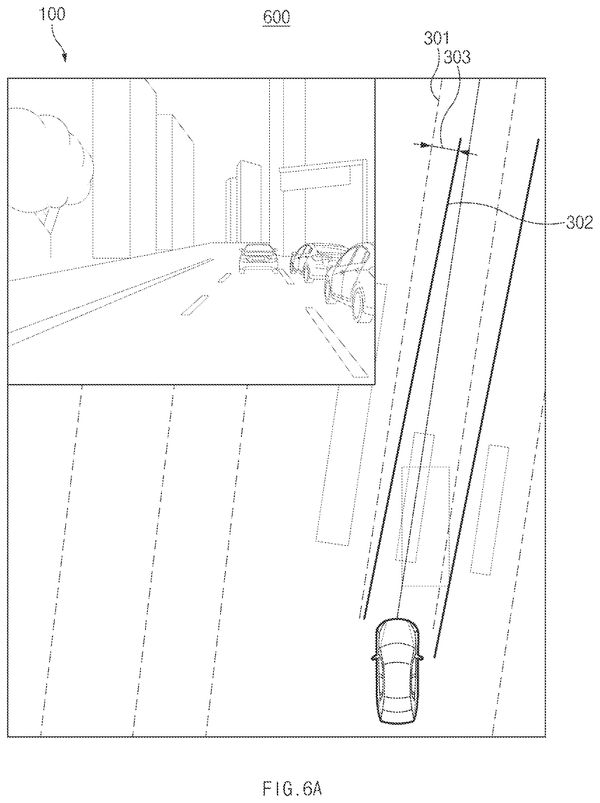

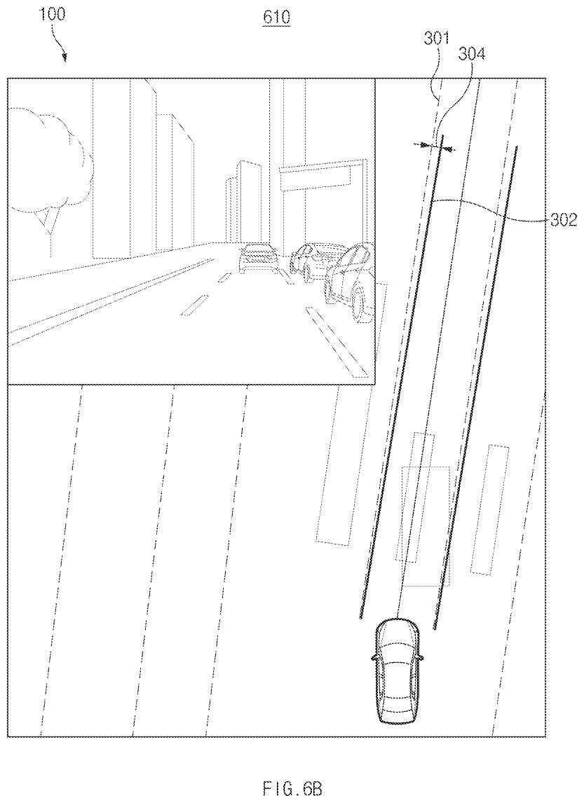

Hereinafter, with reference to FIGS. 5 to 6B, an example of an operation in which the vehicle control device 100 may reduce or remove a positioning bias included in each of a plurality of candidate datasets will be described below.

FIG. 5 shows an example of forward positioning or reverse positioning performed by a vehicle control device. FIGS. 6A and 6B illustrate an example for explaining an operation of a vehicle control device to reduce or remove a positioning bias. The vehicle control device 100 of FIGS. 5 to 6B may be referred to the vehicle control device 100 of FIG. 1.

Referring to FIG. 5, an example 500 of a simulator image logging driving data of the vehicle 210 is shown. In the example 500, the vehicle control device 100 may identify a time period including a time point at which line sensing data (e.g., line sensing data 140 of FIG. 1) is obtained.

For example, the vehicle control device 100 may identify a first time point 501 at which an error between the line sensing data and the line information is identified. The first time point 501 may include a time point at which a line (e.g., the second line 302 in FIG. 3) included in the line sensing data is not identified. The first time point 501 may include a time point at which the line (e.g., the second line 302 in FIG. 3) included in the line sensing data (is misrecognized or misread).

For example, the vehicle control device 100 may identify a second time point 502 at which the error between line sensing data and line information is reduced. A case where the error is reduced may include a case where the error is less than a threshold.

The vehicle control device 100 may identify a positioning bias by performing forward positioning based on a first direction 505 (e.g., the driving direction of the vehicle) from the first time point 501 to the second time point 502.

After performing forward positioning, the vehicle control device 100 determine whether the positioning bias has been reduced or removed by performing reverse positioning based on a second direction 506 from the second time point 502 to the first time point 501 (e.g., the direction opposite to the driving direction of the vehicle). The first direction 505 may be opposite to the second direction 506.

Referring to FIG. 6A, an example 600 of an image expressing line sensing data and line information identified at the first time point 501 is shown. In the example 600, the vehicle control device 100 may identify an error 303 of the second line 302 with respect to the first line 301. The vehicle control device 100 may perform forward positioning based on a first direction (e.g., the driving direction of the vehicle) until the second time point 502 at which the error of the second line 302 with respect to the first line 301 is less than a threshold.

After performing forward positioning, the vehicle control device 100 determine whether the positioning bias has been reduced or removed by performing reverse positioning based on a second direction (e.g., the direction opposite to the driving direction of the vehicle).

The vehicle control device 100 may correct line sensing data based on line information by performing reverse positioning. The vehicle control device 100 may reduce or remove the positioning bias by correcting the line sensing data.

Referring to FIG. 6B, an example 610 of an image expressing line sensing data and line information identified after performing reverse positioning is shown. In the example 610, the vehicle control device 100 may identify another error 304 of the second line 302 with respect to the first line 301. The other error 304 may be smaller than the error 303.

The vehicle control device 100 may identify that a positioning bias has been removed if the statistical quantity of the other error 304 of the second line 302 with respect to the first line 301 identified at the time point 502 after performing reverse positioning is smaller than the statistical quantity of the error 303 of the second line 302 with respect to the first line 301 identified at the first time point 501 before performing forward positioning.

If the positioning bias has not been removed after performing reverse positioning on each of the plurality of candidate datasets, the vehicle control device 100 may identify, as a first dataset, a candidate dataset corresponding to the second line 302.

If the positioning bias has been removed after performing reverse positioning on each of the plurality of candidate datasets, the vehicle control device 100 may identify, as a second dataset, a candidate dataset corresponding to the second line 302.

For example, a first dataset of the plurality of candidate datasets may include a sensor bias and/or a positioning bias.

For example, a second dataset of the plurality of candidate datasets may include a sensor bias, a positioning bias, and/or line change information indicating actual line change.

The vehicle control device 100 may use not only the driving data of the vehicle 210 but also the driving data of another vehicle that is distinct from the vehicle 210 to obtain a plurality of candidate datasets. The driving data of the another vehicle may include line sensing data identified by the another vehicle. The vehicle control device 100 may increase the number of samples to be used in a chi-squared test by using driving data of other vehicles. The vehicle control device 100 may determine line change more precisely by increasing the number of samples to be used in the chi-squared test. The vehicle control device 100 may provide a crowd-sourcing-based map change detection system capable of collecting and processing driving data of multiple vehicles by using driving data of other vehicles.

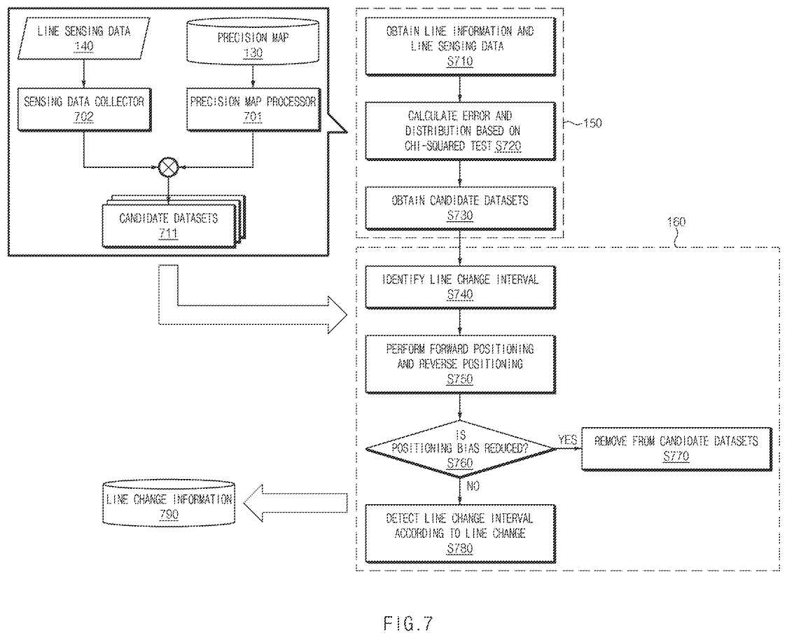

FIG. 7 shows an example of a flowchart showing the operation of a vehicle control device. Hereinafter, it is assumed that the vehicle control device 100 of FIG. 1 performs the process of FIG. 7. Additionally, in the description of FIG. 7, operations described as being performed by the device may be understood as being controlled by the processor 110 of the vehicle control device 100. The operations in FIG. 7 may be performed sequentially, but is not necessarily performed sequentially. For example, the order of the operations may be changed, and at least two operations may be performed in parallel.

Referring to FIG. 7, the vehicle control device 100 may perform operations S710 to S730 based on the execution of the line change candidate detector 150. The vehicle control device 100 may perform operations S740 to S780 based on the execution of the line change detector 160.

In operation S710, the vehicle control device may obtain line information and line sensing data. The line information may be included in the precision map 130. For example, the line sensing data 140 may be processed by a sensing data collector 702. The line information may be processed by a precision map processor 701. The vehicle control device may compare the line information and the line sensing data 140. The sensing data collector 702 and/or the precision map processor 701 may be included in the line change candidate detector 150.

In operation S720, the vehicle control device may calculate error and distribution based on a chi-squared test. The vehicle control device may calculate the error and the distribution by comparing the line information and the line sensing data 140.

In operation S730, the vehicle control device may obtain a plurality of candidate datasets 711 for identifying an actual line change by calculating the error and the distribution. The vehicle control device may calculate the error and the distribution using Equation 1 to Equation 3. Statistical quantities corresponding to the plurality of candidate datasets respectively may be included in the area 420 of FIG. 4.

In operation S740, the vehicle control device may identify a line change interval using the plurality of candidate datasets. The line change interval may include an interval in which the error between a first line identified by the line information (e.g., the first line 301 in FIG. 3) and a second line identified by the line sensing data (e.g., the second line 302 in FIG. 3) is identified.

In operation S750, the vehicle control device may perform forward positioning and/or reverse positioning on each of a plurality of candidate datasets. In other words, the vehicle control device may perform a positioning bias removal process (also referred to as a positioning bias reduction process) to attempt to reduce or remove a positioning bias (also referred to as a localization bias) from each of the plurality of candidate datasets. The vehicle control device 100 may reduce or remove a positioning bias included in each of the plurality of candidate datasets by performing forward positioning and/or reverse positioning.

In operation S760, the vehicle control device 100 may determine whether the positioning bias has been reduced based on performing forward positioning and/or reverse positioning.

If the positioning bias has been reduced (e.g., operation S760—YES), in operation S770, the vehicle control device may remove, from the plurality of candidate datasets, a candidate dataset (e.g., the first dataset) with the reduced positioning bias. In other words, if the positioning bias has been reduced, the vehicle control device may identify an error corresponding to the candidate dataset as an error caused by the positioning bias. The vehicle control device may remove a candidate dataset identified as containing an error due to the positioning bias from the plurality of candidate datasets for identifying an actual line change.

If the positioning bias has not been reduced (e.g., operation S760—NO), in operation S780, the vehicle control device may detect a line change interval due to a line change. For example, the vehicle control device may identify line change information 790 that includes a candidate dataset (e.g., a second dataset) in which the positioning bias has not been reduced. If the positioning bias has not been reduced, the vehicle control device may identify the line change information 790 by determining that the error is due to an actual line change.

The vehicle control device may use the line change information 790 to manage information on an actual line change in a real environment. The vehicle control device may control an autonomous vehicle (e.g., the vehicle 210 in FIG. 2) using the line change information 790.

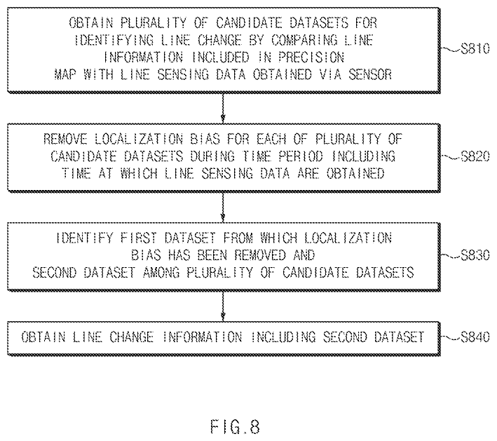

FIG. 8 shows an example of a flowchart showing a vehicle control method. Hereinafter, it is assumed that the vehicle control device 100 of FIG. 1 performs the process of FIG. 8. Additionally, in the description of FIG. 8, operations described as being performed by the device may be understood as being controlled by the processor 110 of the vehicle control device 100. The operations in FIG. 8 may be performed sequentially, but is not necessarily performed sequentially. For example, the order of the operations may be changed, and at least two operations may be performed in parallel.

In operation S810, the vehicle control method may include obtaining a plurality of candidate datasets for identifying a change in line by comparing line information included in a precision map and line sensing data obtained via a sensor. For example, the vehicle control method may include comparing a first line included in line information and a second line included in line sensing data, based on a chi-squared test. The vehicle control method may include obtaining a plurality of candidate datasets based on a statistical quantity representing an error between the first line and the second line.

In operation S820, the vehicle control method may include identifying a positioning bias for each of the plurality of candidate datasets during a time period including a time point at which the line sensing data is obtained. The time period may include the first time point 501 and/or the second time point 502 of FIG. 5. The vehicle control method may include determining whether the positioning bias has been removed by correcting lines included in the plurality of candidate datasets, respectively. The vehicle control method may include determining whether the positioning bias has been removed by performing forward positioning and/or reverse positioning.

In operation S830, the vehicle control method may include identifying a first dataset from which the positioning bias has been removed and a second dataset among the plurality of candidate datasets. The second dataset may include a candidate dataset from which the positioning bias has not been removed. The second dataset may represent information indicative of an actual line change.

In operation S840, the vehicle control method may include obtaining line change information including the second dataset. The vehicle control method may include controlling the vehicle based on the line change information.

For example, the vehicle control method may include transferring (or authorizing) control of the vehicle to a user by identifying an actual line change using the line change information. The vehicle control device that performs the vehicle control method may prevent accidents by transferring control of the vehicle to the user so as to switch from autonomous driving to manual driving in an interval where there is a change in line based on the line change information. In addition, the vehicle control device selectively updates only databased intervals on a precision map (e.g., HD map) based on the MMS (mobile mapping system), thus taking relatively less time and cost than updating all intervals.

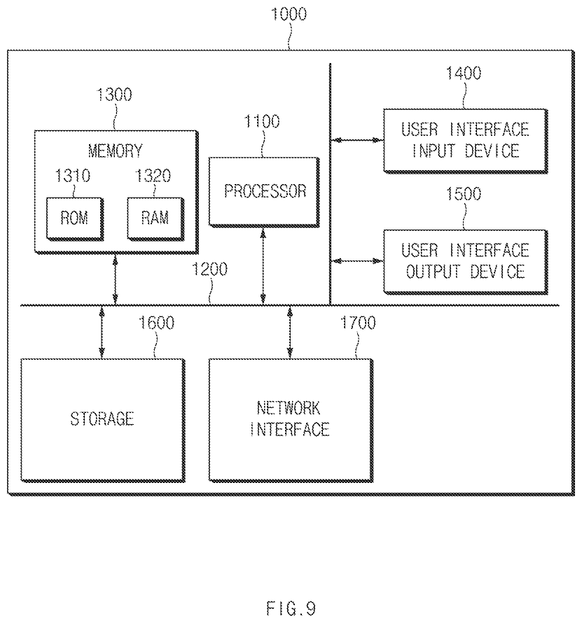

FIG. 9 shows a computing system related to a vehicle control device or a vehicle control method.

Referring to FIG. 9, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read-only memory (ROM) and a random-access memory (RAM).

Thus, the operations of the method or the algorithm described in connection with the example embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

According to an aspect of the present disclosure, a vehicle control device may include a processor, a memory, and a sensor. The processor may obtain a plurality of candidate datasets for identifying a change in line, by comparing line information included in a precision map and line sensing data obtained via the sensor, remove a positioning bias for each of the plurality of candidate datasets during a time period including a time point at which the line sensing data is obtained, identify a first dataset from which the positioning bias has been removed and a second dataset that is distinct from the first dataset among the plurality of candidate datasets, obtain line change information including the second dataset, and control a vehicle based on the line change information.

The processor may identify a first line included in the line information, identify a second line corresponding to the first line using the line sensing data, identify a statistical quantity representing an error of the second line with respect to the first line, and obtain the plurality of candidate datasets including a candidate dataset corresponding to the second line if the statistical quantity is greater than a specified value.

The candidate dataset corresponding to the second line may include at least one of a sensor bias indicating a misrecognition of the sensor, the positioning bias, or line change information representing a change in an actual line corresponding to the second line, or any combination thereof, if the statistical quantity is greater than the specified value.

The processor may identify a first line included in the line information and a second line included in the line sensing data and corresponding to the first line, and identify a statistical quantity representing an error of the second line with respect to the first line, based on a chi-squared test, by comparing a location of the first line with a location of the second line.

The processor may further remove a sensor bias representing misrecognition of the sensor through filtering.

The processor may identify a first line included in the line information and a second line included in the line sensing data and corresponding to the first line, identify a first time point at which the second line is identified via the sensor, identify the positioning bias by performing forward positioning based on a first direction from the first time point to a second time point at which an error of the second line with respect to the first line is less than a threshold value, and determine whether the positioning bias has been removed by performing reverse positioning based on a second direction from the second time point to the first time point.

The processor may identify the candidate dataset as the first dataset if the positioning bias has not been removed after performing the reverse positioning on the candidate dataset.

The processor may identify the candidate dataset as the second dataset if the positioning bias has been removed after performing the reverse positioning on the candidate dataset.

The processor may identify that the positioning bias has been removed if another statistical quantity of another error of the second line with respect to the first line identified at the first time point after performing the reverse positioning is smaller than a statistical quantity of the error of the second line with respect to the first line identified at the first time point before performing the forward positioning.

The line sensing data includes at least one of a line, a road boundary shape, a road sign, or a road marking, or any combination thereof.

According to an aspect of the present disclosure, a vehicle control method may include obtaining a plurality of candidate datasets for identifying a change in line, by comparing line information included in a precision map and line sensing data obtained via a sensor, removing a positioning bias for each of the plurality of candidate datasets during a time period including a time point at which the line sensing data is obtained, identifying a first dataset from which the positioning bias has been removed and a second dataset that is distinct from the first dataset among the plurality of candidate datasets, obtaining line change information including the second dataset, and controlling a vehicle based on the line change information.

The obtaining of the plurality of candidate datasets may include identifying a first line included in the line information, identifying a second line corresponding to the first line using the line sensing data, identifying a statistical quantity representing an error of the second line with respect to the first line, and obtaining the plurality of candidate datasets including a candidate dataset corresponding to the second line if the statistical quantity is greater than a specified value.

The candidate dataset corresponding to the second line may include at least one of a sensor bias indicating a misrecognition of the sensor, the positioning bias, or line change information representing a change in an actual line corresponding to the second line, or any combination thereof, if the statistical quantity is greater than the specified value.

The obtaining of the plurality of candidate datasets may include identifying a first line included in the line information and a second line included in the line sensing data and corresponding to the first line, and identifying a statistical quantity representing an error of the second line with respect to the first line, based on a chi-squared test, by comparing a location of the first line with a location of the second line.

The vehicle control method may further include removing a sensor bias representing misrecognition of the sensor through filtering.

The vehicle control method may further include identifying a first line included in the line information and a second line included in the line sensing data and corresponding to the first line, identifying a first time point at which the second line is identified via the sensor, identifying the positioning bias by performing forward positioning based on a first direction from the first time point to a second time point at which an error of the second line with respect to the first line is less than a threshold, and determining whether the positioning bias has been removed by performing reverse positioning based on a second direction from the second time point to the first time point.

The determining of whether the positioning bias has been removed may include identifying the candidate dataset as the first dataset if the positioning bias has not been removed after performing the reverse positioning on the candidate dataset.

The determining of whether the positioning bias has been removed may include identifying the candidate dataset as the second dataset if the positioning bias has been removed after performing the reverse positioning on the candidate dataset.

The determining of whether the positioning bias has been removed may include identifying that the positioning bias has been removed if another statistical quantity of another error of the second line with respect to the first line identified at the first time point after performing the reverse positioning is smaller than a statistical quantity of the error of the second line with respect to the first line identified at the first time point before performing the forward positioning.

The line sensing data may include at least one of a line, a road boundary shape, a road sign, or a road marking, or any combinations thereof.

The above description is merely illustrative of the technical idea of the present disclosure, and various modifications and variations may be made without departing from the essential characteristics of the present disclosure by those skilled in the art to which the present disclosure pertains.

Accordingly, the one or more example embodiment disclosed in the present disclosure is not intended to limit the technical idea of the present disclosure but to describe the present disclosure, and the scope of the technical idea of the present disclosure is not limited by the example embodiment. The scope of protection of the present disclosure should be interpreted by the following claims, and all technical ideas within the scope equivalent thereto should be construed as being included in the scope of the present disclosure.

The present technology is for using u sensing data including noise.

The present technology is for identifying map change intervals using sensing data and a precision map.

The present technology is for determining whether there is a change in an actual line by comparing line sensing data with line information included in a precision map based on a chi-squared test.

In addition, various effects may be provided that are directly or indirectly understood through the disclosure.

Hereinabove, although the present disclosure has been described with reference to example embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle control device comprising:
a processor;
memory; and
a sensor,
wherein the processor is configured to:
determine, based on a comparison between line information included in a road map and line sensing data obtained via the sensor, a plurality of candidate datasets for identifying a change in a line associated with a road, wherein the plurality of candidate datasets correspond to a time period associated with the line sensing data;
perform a positioning bias reduction process on each of the plurality of candidate datasets;
identify, among the plurality of candidate datasets:
a first dataset from which a positioning bias has been reduced, and
a second dataset different from the first dataset;
determine, based on the second dataset, line change information; and
control, based on the line change information, a vehicle.

2. The vehicle control device of claim 1, wherein the processor is configured to determine the plurality of candidate datasets by:
identifying a first line included in the line information;
identifying, based on the line sensing data, a second line corresponding to the first line;
determining a statistical quantity representing a deviation of the second line with respect to the first line; and
determining, based on the statistical quantity being greater than a threshold value, a candidate dataset, of the plurality of candidate datasets, that corresponds to the second line.

3. The vehicle control device of claim 2, wherein the candidate dataset corresponding to the second line comprises at least one of: a sensor bias indicating a misreading of the sensor, the positioning bias, or the line change information representing a change associated with the second line.

4. The vehicle control device of claim 1, wherein the processor is further configured to:
identify a first line included in the line information;
identify, based on the line sensing data, a second line corresponding to the first line; and
determine, based on a comparison of a location of the first line with a location of the second line, a statistical quantity representing a deviation of the second line with respect to the first line.

5. The vehicle control device of claim 1, wherein the processor is further configured to:
remove, through filtering, a sensor bias representing misreading of the sensor.

6. The vehicle control device of claim 1, wherein the processor is configured to perform the positioning bias reduction process by:
identifying a first line included in the line information;
identifying, based on the line sensing data, a second line corresponding to the first line;
determining a first time at which the second line was detected by the sensor;
determining the positioning bias by performing forward positioning in a first direction from the first time to a second time at which a deviation of the second line with respect to the first line is less than a threshold value; and
determining whether the positioning bias has been reduced by performing reverse positioning in a second direction from the second time to the first time.

7. The vehicle control device of claim 6, wherein the processor is configured to identify the first dataset by:
identifying a candidate dataset, of the plurality of candidate datasets, as the first dataset based on the positioning bias having been reduced after the reverse positioning is performed on the candidate dataset.

8. The vehicle control device of claim 6, wherein the processor is configured to identify the second dataset by:
identifying a candidate dataset, of the plurality of candidate datasets, as the second dataset based on the positioning bias not having been reduced after the reverse positioning is performed on the candidate dataset.

9. The vehicle control device of claim 6, wherein the processor is further configured to determine that the positioning bias has been reduced based on a first statistical quantity being less than a second statistical quantity,
wherein the first statistical quantity is associated with a second deviation of the second line with respect to the first line after performing the reverse positioning, and
wherein the second statistical quantity is associated with the deviation of the second line with respect to the first line before performing the forward positioning.

10. The vehicle control device of claim 1, wherein the line sensing data comprises at least one of: a line, a road boundary shape, a road sign, or a road marking.

11. A method performed by an apparatus of a vehicle, the method comprising:
determining, based on a comparison between line information included in a road map and line sensing data obtained via a sensor, a plurality of candidate datasets for identifying a change in a line associated with a road, wherein the plurality of candidate datasets correspond to a time period associated with the line sensing data;
performing a positioning bias reduction process on each of the plurality of candidate datasets;
identifying, among the plurality of candidate datasets:
a first dataset from which a positioning bias has been reduced, and
a second dataset different from the first dataset;
determining, based on the second dataset, line change information; and
controlling, based on the line change information, the vehicle.

12. The method of claim 11, wherein the determining of the plurality of candidate datasets comprises:
identifying a first line included in the line information;
identifying, based on the line sensing data, a second line corresponding to the first line;
determining a statistical quantity representing a deviation of the second line with respect to the first line; and
determining, based on the statistical quantity being greater than a threshold value, a candidate dataset, of the plurality of candidate datasets, that corresponds to the second line.

13. The method of claim 12, wherein the candidate dataset corresponding to the second line comprises at least one of: a sensor bias indicating a misreading of the sensor, the positioning bias, or the line change information representing a change associated with the second line.

14. The method of claim 11, further comprises:
identifying a first line included in the line information;
identify, based on the line sensing data, a second line corresponding to the first line; and
determining, based on a comparison of a location of the first line with a location of the second line, a statistical quantity representing a deviation of the second line with respect to the first line.

15. The method of claim 11, further comprising:
removing, through filtering, a sensor bias representing misreading of the sensor.

16. The method of claim 11, wherein the performing of the positioning bias reduction process comprises:
identifying a first line included in the line information;
identifying, based on the line sensing data, a second line corresponding to the first line;
determining a first time at which the second line was detected by the sensor;
determining the positioning bias by performing forward positioning in a first direction from the first time to a second time at which a deviation of the second line with respect to the first line is less than a threshold; and
determining whether the positioning bias has been reduced by performing reverse positioning in a second direction from the second time to the first time.

17. The method of claim 16, wherein the identifying of the first dataset comprises:
identifying a candidate dataset, of the plurality of candidate datasets, as the first dataset based on the positioning bias having been reduced after the reverse positioning is performed on the candidate dataset.

18. The method of claim 16, wherein the identifying of the second dataset comprises:
identifying a candidate dataset, of the plurality of candidate datasets, as the second dataset based on the positioning bias not having been reduced after the reverse positioning is performed on the candidate dataset.

19. The method of claim 16, further comprising:
determining that the positioning bias has been reduced based on a first statistical quantity being less than a second statistical quantity,
wherein the first statistical quantity is associated with a second deviation of the second line with respect to the first line after performing the reverse positioning, and
wherein the second statistical quantity is associated with the deviation of the second line with respect to the first line before performing the forward positioning.

20. The method of claim 11, wherein the line sensing data comprises at least one of: a line, a road boundary shape, a road sign, or a road marking.
